(19) United States
(12) Patent Application Publication
(10) Pub. No.: US 2002/0113386 A1
(43) Pub. Date: Aug. 22, 2002

(54) Bag body for bowling bags

(76) Inventor: Sung Hoan Be, Taegu (KR)

Correspondence Address: Richard T. Holzmann, 2055 Imperial Avenue, Davis, CA, 95616-3166, US

(21) Appl. No.: 09/785,582

(22) Filed: Feb. 20, 2001

(51) Int. Cl. B62B 1/00

(52) U.S. Cl. 280/47.19; 280/47.26

(57) ABSTRACT

Disclosed herein is a bag body for bowling bags. The bag body includes an elongated body member that is provided with a cavity and side open ends. Two lids are hinged to the body member at the side open ends of the body member to selectively open and close the side open ends, and provided with an exterior pouch. A partition is formed in the center portion of the cavity of the body member to divide the cavity into two sub-cavities. The partition may be pectinate and integrated with the body member into a single structure. The bag body may further comprise a cover made of synthetic resin of leather, the cover being provided with an auxiliary pouch and secured to the front portion of the body member by means of bars and bolts.

### BACKGROUND OF THE INVENTION

1. Field of the Invention

The present invention relates generally to bowling bags used to keep and carry bowling equipment such as bowling balls and bowling shoes, and more particularly to a bowling bag in which a partition is formed in the center portion of the cavity of the bag to divide the cavity into two sub-cavities, thereby allowing bowling balls to be individually put into and withdrawn from the bag. The present invention is an improvement over U.S. Pat. No. 6,109,627 entitled “bowling bag” and Korean Pat. Appln. No. 10-2000-0056673 entitled “bottom case for bowling bags”.

2. Description of the Prior Art

U.S. Pat. No. 6,109,627 discloses a bowling ball carrier invented by this inventor, in which a plurality of bowling bags are attached to a carrier with one laid on top of another, and fabric lids are sewn around the front openings of bag bodies or lids of synthetic resin are respectively hinged around the front openings of the bag bodies to allow bowling balls to be put into and withdrawn from the bags. The lids are formed in the fronts of bag bodies, since the bowling balls cannot be put into or withdrawn from the stacked bags if lids are formed on the tops of the bag bodies. Accordingly, two bowling balls are kept in a single cavity, so a problem occurs in which scratches and noise are created due to the collision between the balls. Additionally, the lids are formed on the fronts of the bowling bags, so a bowling ball present in the bowling bag easily falls out because of a user's carelessness and external impact while the bowling ball carrier is erect.

In order to overcome the shortcomings of U.S. Pat. No. 6,109,627, U.S. Pat No. 6,099,023 has been proposed by this inventor. U.S. Pat. No. 6,099,023 discloses a bottom case for bowling bags in which one or two partition walls are integrally formed in the bottom case, thus forming one, two or three cells in the case and allowing bowling balls to be individually kept in the cells. The bowling bag equipped with the bottom case can eliminate the problem of bowling balls colliding with each other, but creates another problem in which a bowling ball present in the bag easily can fall out because a single lid is formed in the front of the bowling bag. This problem causes inconvenience to a user in which the user has to put a bowling ball into the bowling bag and to withdraw a bowling ball from the bowling bag when the bowling ball carrier is laid on a floor.

### SUMMARY OF THE INVENTION

Accordingly, the present invention has been made keeping in mind the above problems occurring in the prior art, and an object of the present invention is to provide a bowling bag, in which its cavity is divided into two sub-cavities and its side open ends are respectively equipped with two lids, so that two bowling balls can be individually put into and individually withdrawn from the bag.

In order to accomplish the above object, the present invention provides a bag body for bowling bags, comprising an elongated body member having a cavity and side open ends, two lids hinged to the body member at the side open ends of the body member to selectively open and close the side open ends, and provided with an exterior pouch, and a partition formed in the center portion of the cavity of the body member to divide the cavity into two sub-cavities.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a bag body for bowling bags in accordance with the present invention;

FIG. 2 is a horizontal cross-section of FIG. 1;

FIG. 3 is a vertical cross-section of FIG. 1;

FIG. 4 is a perspective view showing a partition in accordance with another embodiment of the present invention;

FIGS. 5 and 6 are perspective views showing bag bodies provided with covers;

FIG. 7 is a perspective view showing a bag body provided with casters; and

FIGS. 8 to 12 are views showing bag bodies for bowling bags in accordance with other embodiments of the present invention.

### DESCRIPTION OF THE PREFERRED EMBODIMENTS

Reference now should be made to the drawings, in which the same reference numerals are used throughout the different drawings to designate the same or similar components.

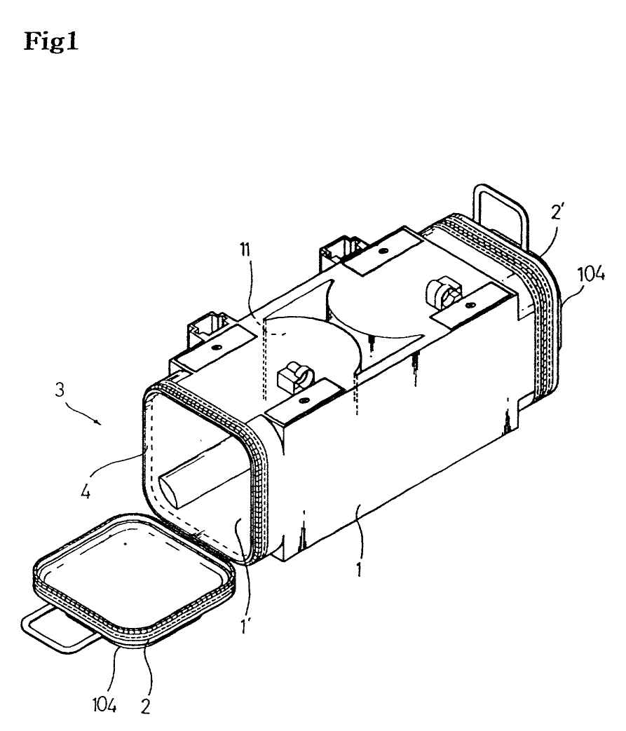

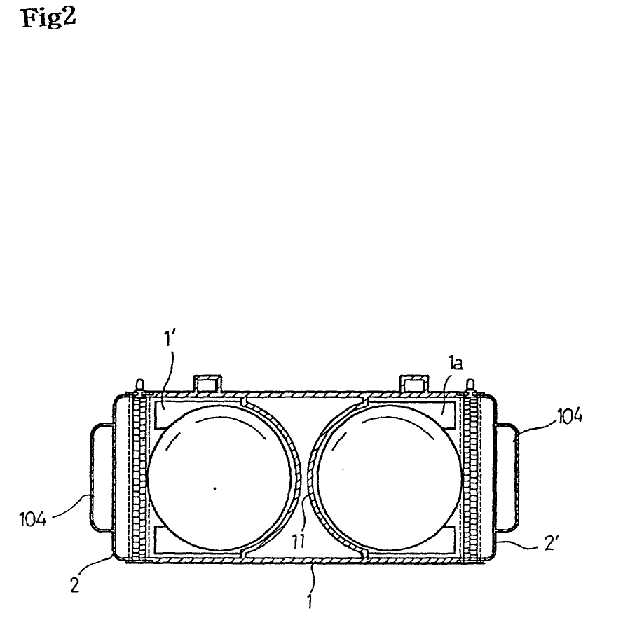

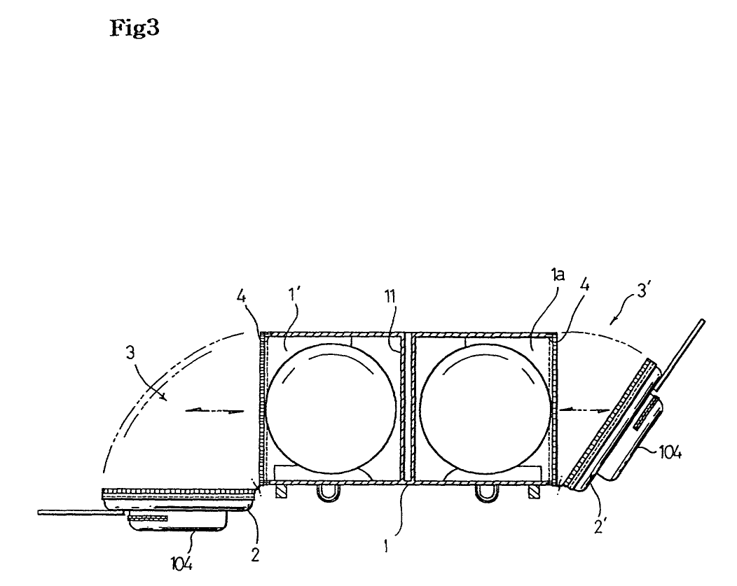

With reference to FIGS. 1 to 3, a bag body for bowling bags of the present invention includes an elongated body member 1 that is provided with a cavity and side open ends. Two lids 2 are hinged to the body member 1 at the side open ends of the body member 1 to selectively open and close the side open ends, and provided with an exterior pouch 104. A partition 11 is formed in the center portion of the cavity of the body member 1 to divide the cavity into two sub-cavities 1′ and 1a.

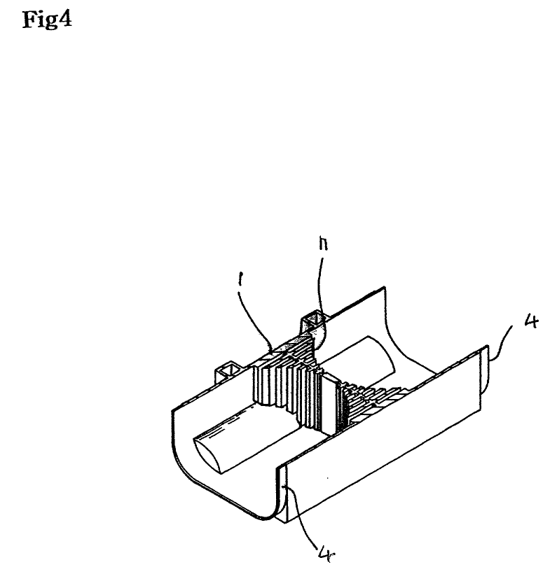

Referring to FIG. 4, the partition 11 may be pectinate and integrated with the body member 1 into a single structure.

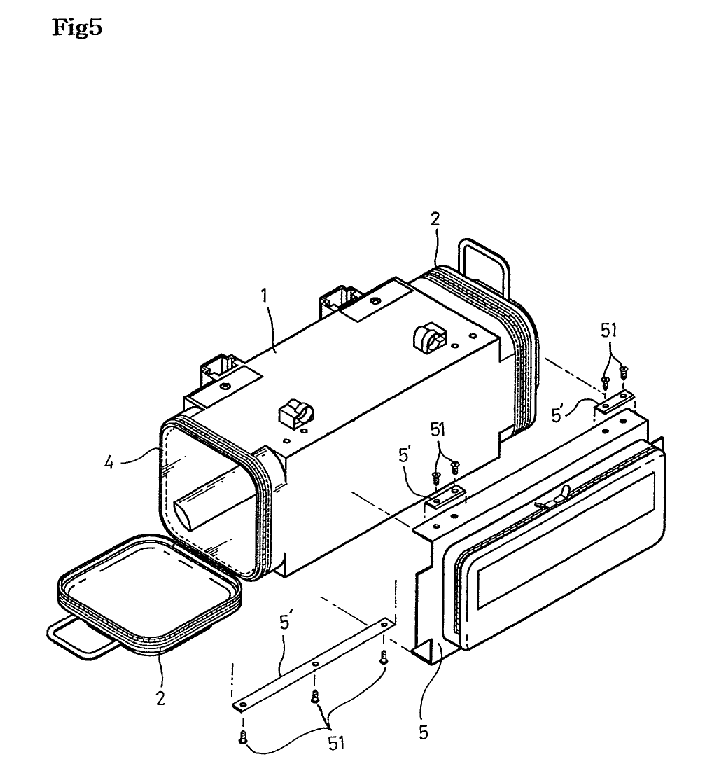

As shown in FIG. 5, the bag body may further comprise a cover 5 made of synthetic resin of leather, and the cover 5 is provided with an auxiliary pouch 104 and secured to the front portion of the body member 1 by means of bars 5′ and bolts 51.

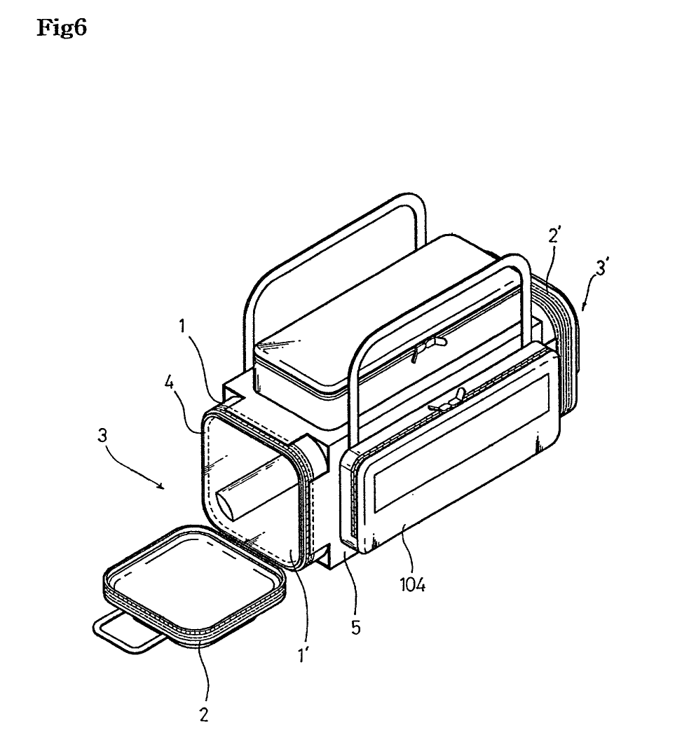

As shown in FIG. 6, the bag body may further comprise a cover 5, and the cover 5 is provided with auxiliary pouches 104 and secured around the body member 1 by means of a bar 5′ and bolts 51.

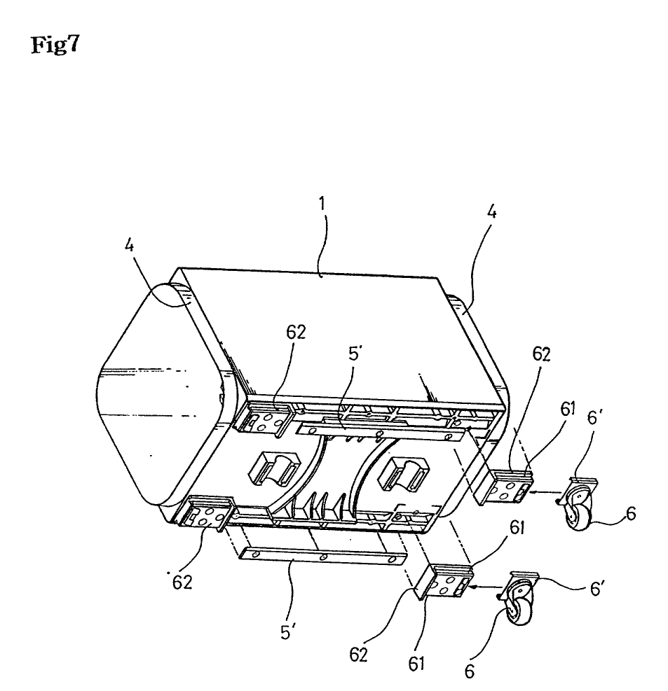

Referring to FIG. 7, the bag body may further comprise a plurality of holding members 62 and a plurality of casters 6. The casters 6 are detachably secured to the holding members 62 secured to the body member 1 with the caster bases 6′ of the casters 6 being fitted into the fitting grooves 61 of the holding members 62.

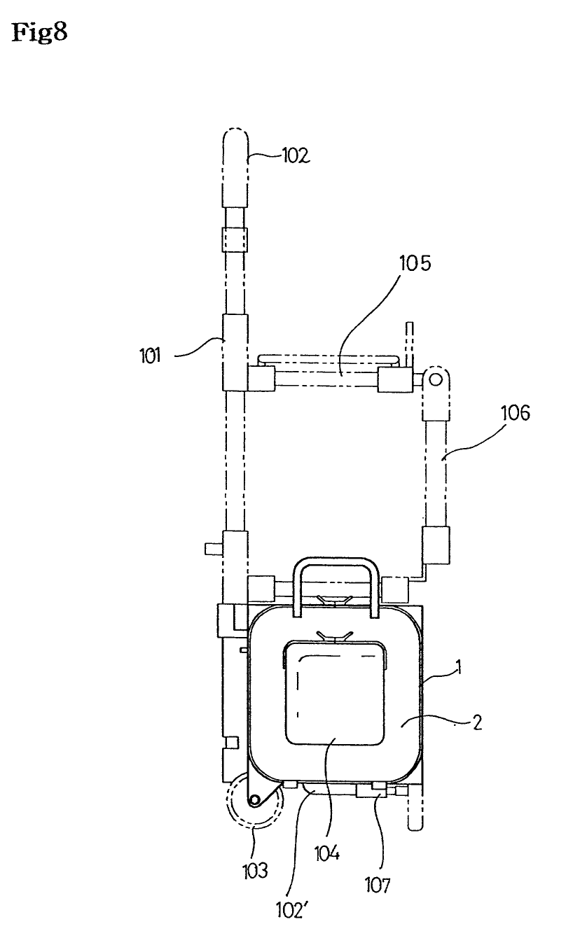

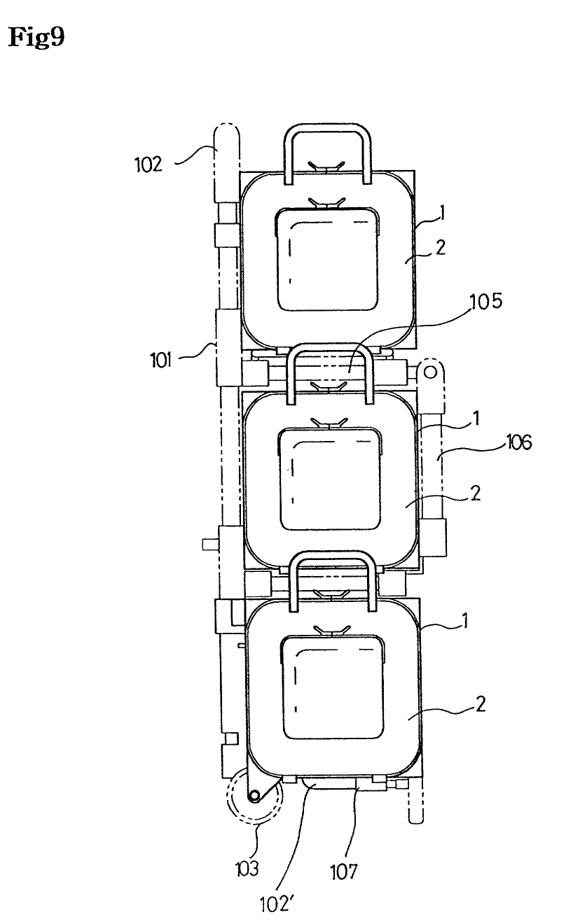

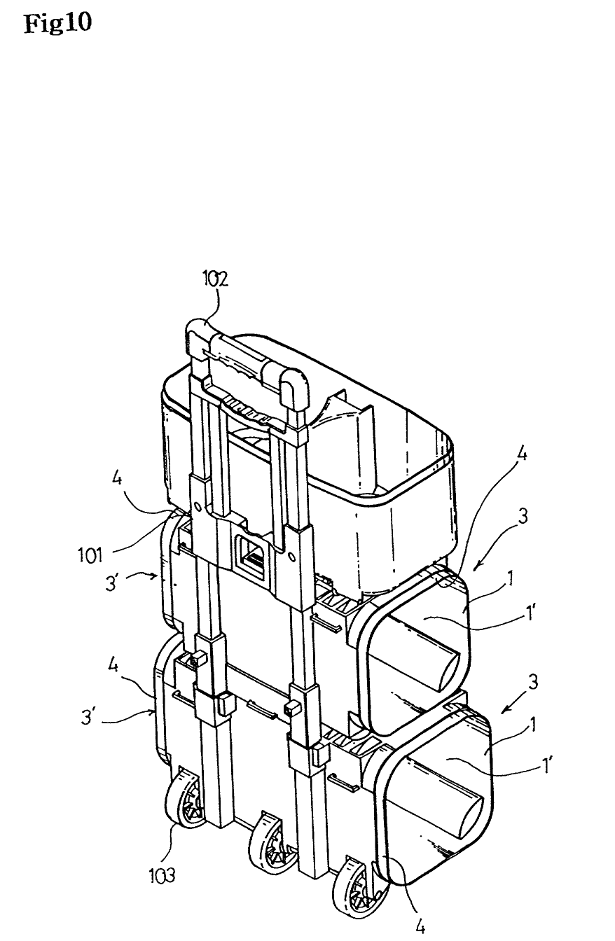

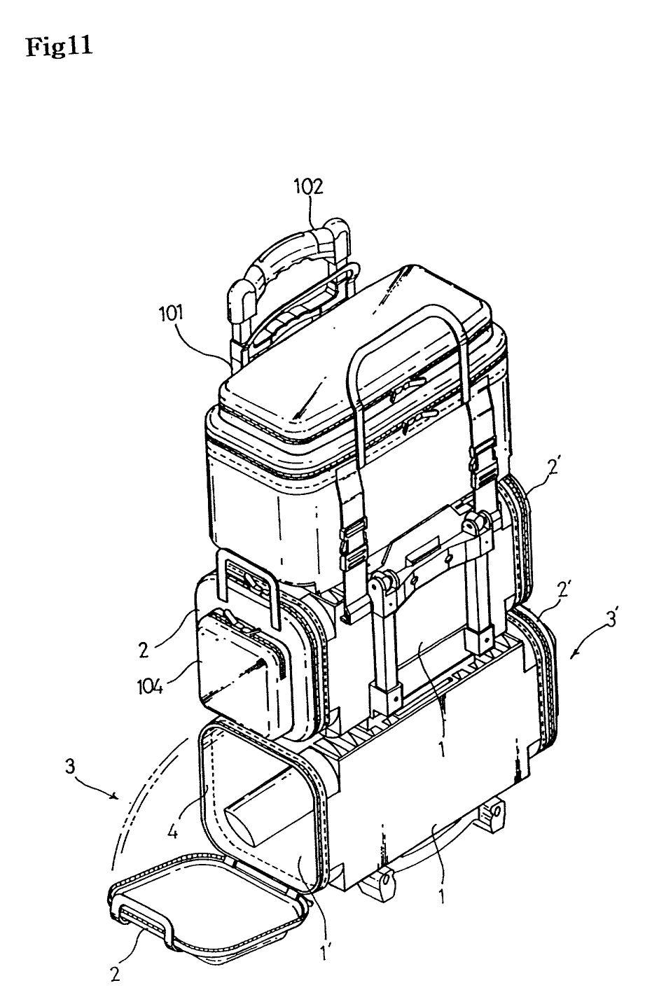

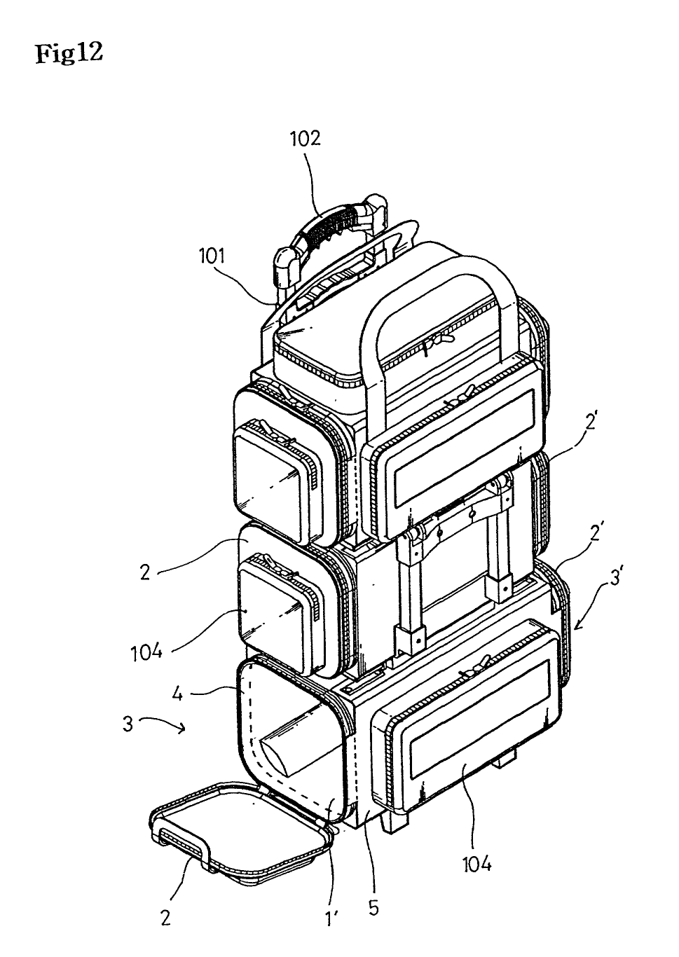

As shown in FIGS. 8 to 12, the bag body may further comprise a carrier 101. The carrier 101 is attached to the body member 1 and composed of a frame 102 and one or more casters 103. The body member 1 may be comprised of two or more sub-bodies, and the sub-bodies are detachably fixed to one another with one laid on top of another.

In accordance with the present invention, the cavity is divided into two sub-cavities 1′ and 1a by the partition 11, and the side open ends 3 and 3′ of the bag are selectively opened and closed using lids 2 and 2′, thereby allowing bowling balls to be selectively put into and withdrawn from the bag.

Accordingly, bowling balls can be individually kept in the sub-cavities 1′ and 1a of the bowling bag, so scratches and noises that may occur due to collisions between bowling balls while being carried in the bowling bag can be prevented. In the case where a plurality of bowling bags are attached to the carrier 101 with one laid on top of another, the bowling balls can be individually put into and individually withdrawn from the bowling bags without the problem of a bowling ball falling out of the bowling bag while the carrier 101 is erect. In addition, the bowling balls are individually kept in the sub-cavities 1′ and 1a, so that the bowling balls can be held stable while the bowling balls are kept and carried in the bags. Moreover, casters 6 may be detachably attached to the body member 1, so the bowling bag of the present invention is advantageous in that a user can carry the bowling bag easily. The body member 1 is covered with the cover 5 made of synthetic resin or leather at its front surface or two or more surfaces, thereby improving the bowling bag's appearance and increasing the accommodating space of the bowling bag by the addition of the pouch. In brief, the bowling bag of the present invention facilitates the keeping and carrying of bowling equipment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A bag body for bowling bags, comprising:
an elongated body member having a cavity and side open ends;
two lids hinged to said body member at the side open ends of said body member to selectively open and close the side open ends, and provided with an exterior pouch; and
a partition formed in the center portion of the cavity of said body member to divide the cavity into two sub-cavities.

2. The bag body according to claim 1, wherein said partition is pectinate and integrated with said body member into a single structure.

3. The bag body according to claim 1, further comprising a cover of synthetic resin of leather, said cover being provided with an auxiliary pouch and secured to the front portion of said body member by means of bars and bolts.

4. The bag body according to claim 1, further comprising a cover, said cover being provided with auxiliary pouches and secured around said body member by means of a bar and bolts.

5. The bag body according to claim 1, further comprising a plurality of holding members and a plurality of casters, said casters being detachably secured to said holding members secured to said body member with the caster bases of said casters being fitted into the fitting grooves of said holding members.

6. The bag body according to claim 1, further comprising a carrier, said carrier being attached to said body member and composed of a frame and one or more casters.

7. The bag body according to claim 4, wherein said body member is comprised of two or more sub-bodies, and said sub-bodies are detachably fixed to one another with one laid on top of another.
